(19) United States
(12) Patent Application Publication
(10) Pub. No.: US 2017/0229737 A1
(43) Pub. Date: Aug. 10, 2017

(54) ION TRANSPORT IN BINARY-SALT IONIC LIQUIDS

(71) Applicant: University of Notre Dame du Lac, South Bend, IN (US)

(72) Inventors: Samuel Seo, South Bend, IN (US); Joan F. Brennecke, South Bend, IN (US)

(73) Assignee: University of Notre Dame du Lac, South Bend, IN (US)

(21) Appl. No.: 15/430,296

(22) Filed: Feb. 10, 2017

Related U.S. Application Data
(60) Provisional application No. 62/293,706, filed on Feb. 10, 2016.

(51) Int. Cl. H01M 10/0568; H01M 10/0569; H01M 10/0525

(52) U.S. Cl. CPC H01M 10/0568; H01M 10/0525; H01M 10/0569; H01M 2300/0028

(57) ABSTRACT

The viscosity of various ionic liquids (IL), the solvent tetraethylene glycol dimethyl ether (G4), and their mixtures, with or without lithium salts, were measured experimentally. Various compositions were studied spectroscopically. Detailed analysis reveals that G4 preferentially solvates cations, leading to a reduction in the interaction energy between cations and anions and a subsequent enhancement in anion mobility. Diffusivity and ionic conductivity of certain compositions were improved at G4 mole fractions below levels required for a “solvate ionic liquid”. When an IL was combined with low amounts of a 1:1 stoichiometric ratio of G4 and lithium salt, the viscosity of composition remained constant and ion mobility increased.

### RELATED APPLICATIONS

This application claims priority under 35 U.S.C. §119(e) to U.S. Provisional Patent Application No. 62/293,706, filed Feb. 10, 2016, which is incorporated herein by reference.

### BACKGROUND OF THE INVENTION

There is significant interest in the use of ionic liquids (ILs) as electrolytes for a wide variety of electrochemical applications, including in batteries. ILs are essentially nonvolatile so they would eliminate safety problems that are prevalent with the flammable organic solvents currently used, especially in lithium ion batteries. However, the properties of ILs suffer from insufficient conductivity. ILs with the bis(trifluoromethylsulfonyl)imide anion (TFSI) are extensively investigated because they can yield ILs with relatively low viscosities and, therefore, higher conductivities. One disadvantage is the TFSI anion is known to associate with metal cations, like lithium cations, so that the transport of lithium ions, whose movement is vital for lithium batteries is less than ideal. Oligoethers are capable of solvating lithium ions when added to a lithium salt of TFSI, resulting in a class of ionic liquids termed as a ‘solvate IL’. Solvate ILs have equimolar amounts of lithium salt and glyme. The melting point and viscosity of these lithium salt and glyme mixtures may be too high for various applications. Accordingly, a solution is needed for more conventional and less flammable ionic liquids whereby an increase in the self-diffusion coefficient (or diffusivity) of metal cations in the composition can be achieved by inhibiting or breaking the association between metal cations and anions. Such a solution to the problem would represent a major advance in the development of ILs for electrochemical applications.

### SUMMARY

The invention provides a composition which inhibits or breaks, for example, the association between metal cations and TFSI anions in an ionic liquid (IL). The composition can also increase the self-diffusion coefficient of metal cations in the IL. The composition can be used for a variety of applications including electrochemical applications.

Accordingly, this disclosure provides an ionic composition comprising: an organic salt having ionic liquid properties below 100° C., and an organometallic salt, wherein a binary-salt mixture of the organic salt and the organometallic salt has ionic conductivity; and an organic solvate (S) having properties to a) chelate a metal cation (M), b) increase the diffusivity of ions in the binary-salt mixture, and c) lower the viscosity of the binary-salt mixture,

wherein the organic solvate binds to the metal cations of the organometallic salt by coordination bonds to weaken the electrostatic interaction of the metal cations with the anions of the mixture, thereby solvating the metal cations from the anions and increasing the ionic conductivity of the binary-salt mixture;

wherein the stoichiometric ratio of the organic solvate (S) and the metal cation (M) in the ionic composition ranges from about 10(S):90(M) to about 70(S):30(M), the vapor pressure of the ionic composition is negligible, and the ionic composition has lower viscosity than a corresponding binary-salt mixture of the organic salt and the organometallic salt that lacks the organic solvate. In some embodiments, the cation of the organic salt having ionic liquid properties comprises an aryl cation. In other embodiments, the cation of the organic salt having ionic liquid properties comprises a non-cyclic alkyl ammonium cation.

In one particular embodiment, the ionic composition comprises:

a) an organic salt comprising N,N-diethyl-N-methyl-N-(2-methoxyethyl)ammonium bis(trifluoromethylsulfonyl)imide ([DEME][TFSI]), N-methyl-N-propylpiperidinyl bis(trifluoromethylsulfonyl)imide ([PP13][TFSI]), or a combination thereof;

b) an organometallic salt comprising lithium bis(trifluoromethylsulfonyl)imide (Li[TFSI]); and

c) a glyme (G) selected from diglyme, triglyme, tetraglyme, or a combination thereof;

wherein the stoichiometric ratio of the glyme (G) and the lithium cation (M) of the organometallic salt is about 50(G):50(M), and concentration of Li[TFSI] is in the range of about 0.3 molal to about 0.4 molal in a mixture of Li[TFSI] and [DEME][TFSI], in a mixture of Li[TFSI] and [PP13][TFSI], or in a mixture of Li[TFSI], [DEME][TFSI], and [PP13][TFSI].

This disclosure also provides a method to increase the self-diffusion coefficient of ions in a composition, the method comprising:

adding an organic solvate to a binary-salt mixture of an organic salt having ionic liquid properties below 100° C., and an organometallic salt to form an ion conducting composition, wherein the stoichiometric ratio of the organic solvate (S) and the metal cation (M) of the organometallic salt ranges from about 60(S):40(M) to about 40(S):60(M), and the concentration of the organometallic salt ranges from about 0.1 molal to about 1 molal in said mixture,

wherein, relative to the binary-salt mixture of the organic salt and the organometallic salt, the ion conducting composition has a) an increased self-diffusion coefficient, b) a higher conductivity, and c) a lower viscosity, and the vapor pressure of the ion conducting composition is negligible.

In various embodiments, triglyme or tetraglyme can be added to a mixture of [DEME][TFSI] or [PP13][TFSI] and Li[TFSI].

A battery or an electrochemical cell containing an electrolyte comprising a composition in any one of the forgoing embodiments, or utilizing a method of increasing the self-diffusion coefficient or mobility of ions, is also described in this disclosure.

To our knowledge, this is the first work to extend the concept of mixtures of glymes and lithium salts to include ionic liquids in a binary-salt composition, where one can take advantage of the lower viscosity of a more conventional ionic liquid (compared to the Li[TFSI]-glyme equimolar solvate), as well as other properties, such as tailored gas solubilities, which are important for use of ILs in lithium-gas batteries.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. Lithium bis(trifluoromethylsulfonyl)imide (left) shown tightly bound by its counter anion. Addition of glyme breaks the complex by solvating the lithium cations (right).

FIG. 2. Raman spectra of mixture of [PP13][TFSI] and Li[TFSI] showing concentration of Li[TFSI] increasing in direction of arrow in the following increments: 0.2M, 0.35M, 0.5M, 0.75M, and 1.0M. Additional vibrational modes increase dues to formation of the complex shown in FIG. 1 (Castriota et al., J. Phys. Chem. A 2005, 109, 92-96)

FIG. 3A-3F. Deconvoluted Raman spectra of —CF₃ peak from mixture of [PP13][TFSI] and Li[TFSI] showing different concentrations of Li[TFSI]. Experimental data represented by line with circles, and solid lines show amount of free [TFSI] decreasing as it coordinates to increasing concentration of lithium.

FIG. 4A-4B. NMR spectra showing up-field shift of ¹³C and ¹⁹F signals due to effect of strong interaction of lithium with oxygen atoms on the [TFSI] anion.

FIG. 5. Viscosity of [PP13][TFSI] as a function of temperature at different concentrations of Li[TFSI] and tetraglyme (shown as TG).

FIG. 6. Viscosity of [DEME][TFSI] as a function of temperature at different concentrations of Li[TFSI] and tetraglyme (shown as TG).

FIG. 7. Diffusivity of neat ionic liquids, ionic liquids containing 0.35M Li[TFSI], and ionic liquids containing 0.35M Li[TFSI] and varying amounts of tetraglyme (shown as TG).

FIG. 8. Diffusivity and viscosity as related by the Stokes-Einstein relationship of individual ionic species in various compositions (tetraglyme shown as TG or as TG1 in 1:1 ratio with Li).

FIG. 9. NMR spectra showing down-field shift of ⁷Li in ionic liquids after addition of tetraglyme (shown as TG4).

FIG. 10. Thermal gravimetric analysis showing thermal stability of various compositions of tetraglyme (TG) (shown as TG1, or TG2 to represent 1:1 or 2:1 ratio with Li, respectively).

FIG. 11A-11D. Raman shift of —CF₃ signal of various ionic liquid mixtures of [PP13][TFSI] showing lithium ion being decomplexed by tetraglyme (shown as TG4).

FIG. 12. Comparison of triglyme (TG3) and tetraglyme (TG4) on diffusivity of various ionic liquid compositions.

FIG. 13. Raman shift of —CF₃ signal of various ionic liquid mixtures of [PP13][TFSI] showing lithium ion being decomplexed by triglyme (TG3).

FIG. 14. Flow diagram of general stepwise procedure for preparing the electrolyte composition.

FIG. 15. Examples of cations and anions used for ionic liquids and examples of ionic liquids in specific combinations.

### DETAILED DESCRIPTION

The properties of ionic liquids are of great interest as potential electrolytes for electrochemical applications because certain classes have melting points near or below ambient temperature, and they are also non-volatile. Hence, much research is pouring into improving ionic liquids as ionic conductors.

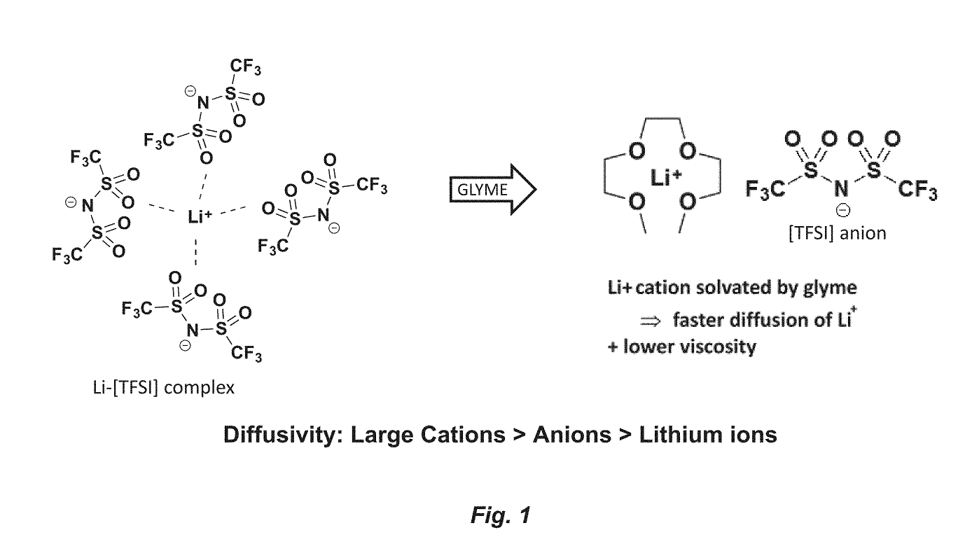

This work investigates compositions that improve the diffusivity of ions in several organic ionic liquids. Bistriflimide, systematically known as bis(trifluoromethylsulfonyl)imide and colloquially as TFSI, is an organic anion with the chemical formula [(CF₃SO₂)₂N]⁻. The TFSI anion can form salts with various organic cations. The TFSI anion is widely used in ionic liquids which can have powerful solvating properties, since it is more stable than more “traditional” counterions such as tetrafluoroborate. This anion is of importance in lithium-ion and lithium metal batteries because of its conductivity. However, efforts to enhance TFSI-type ionic liquids with lithium salts results in slow diffusion of lithium cations because the metal cation is complexed by an aggregate of TFSI anions (FIG. 1). Fast lithium ion mobility is very important for lithium batteries. Regardless of being the smallest species in an ionic liquid (IL)/lithium salt mixture, the lithium cation typically exhibits the slowest diffusion rate compared to either the anion or the cation of the IL (e.g., diffusivity of large cations>anions>lithium cations). It has been reported that each individual lithium ion is coordinated with multiple anions, resulting in poor migration of lithium cations in the electrolyte.

Glymes are known to coordinate with lithium cations. Addition of glyme can competitively inhibit and break the interaction between the lithium cation and the TFSI anion. The lithium cation solvated by the glyme can have significantly better mobility than in the mixture without glyme, which we have demonstrated in our experiments (FIG. 1).

In our earlier work with other collaborators (Sharma et al., Chem. Eng. Sci., 2017, 159, 43-57), we have shown that adding glyme to an ionic liquid such as, 1-n-hexyl-3-methylimidazolium bis(trifluoromethylsulfonyl)imide ([C₆mim][TFSI]), will have an effect on lowering the viscosity of the ionic liquid that is more than would be expected by predictive models. However, improvements in ionic conductivity by lowering its viscosity with increasing amounts of glyme reaches a maximum benefit.

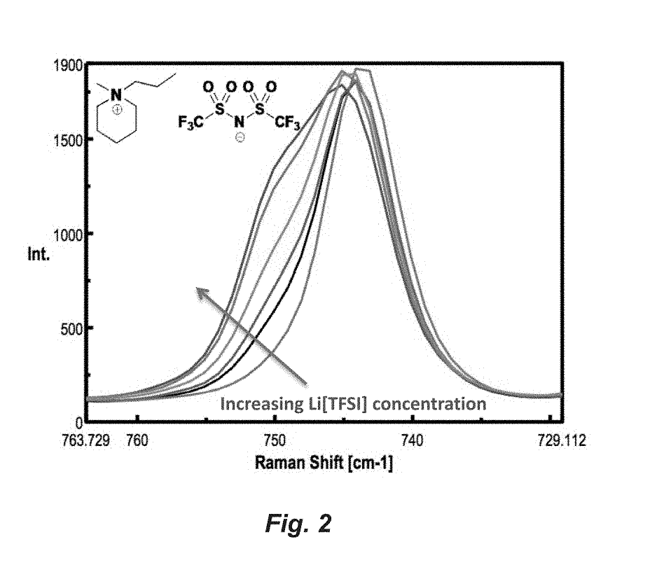

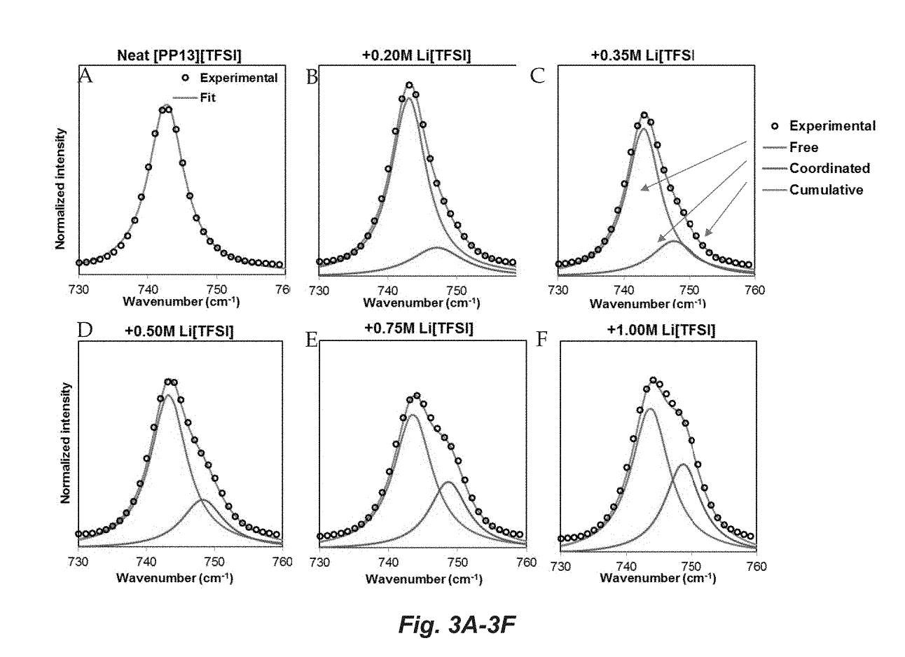

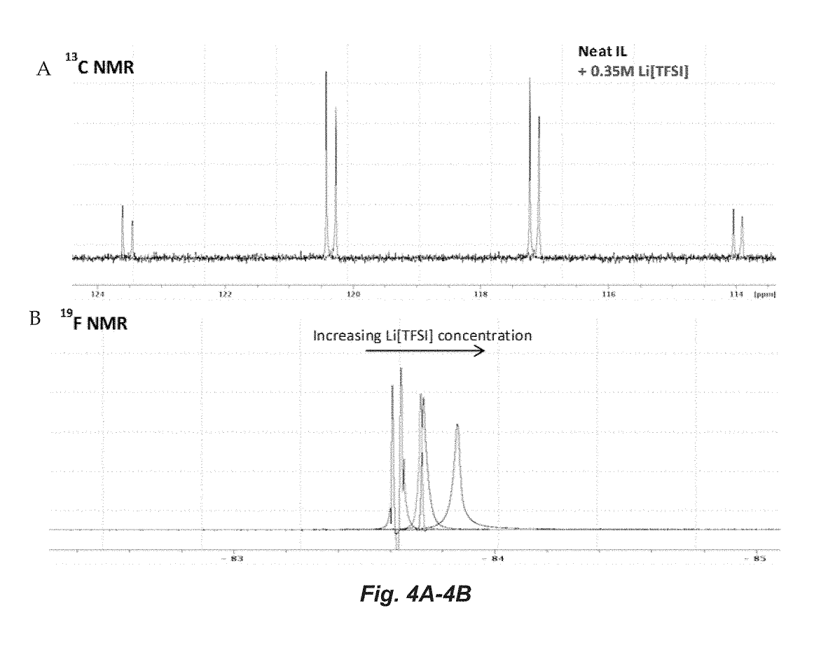

The effect of adding the organometallic salt, lithium bis(trifluoromethylsulfonyl)imide, to an organic ionic liquid such as N,N-diethyl-N-methyl-N-(2-methoxyethyl)ammonium bis(trifluoromethylsulfonyl)imide ([DEME][TFSI]), results in the lithium cation being sequestered by the anion as discussed above (FIG. 1). This effect can be demonstrated by observing changes to the —CF₃ band of the Raman spectrum as the concentration of lithium cation is increased in the ionic liquid (FIG. 2). The —CF₃ vibration mode of free TFSI anions show up around 742 cm⁻¹. Upon addition of Li[TFSI] salt, the interaction between the lithium cation and TFSI anion causes an additional vibration mode to appear near 748 cm⁻¹. The size of the bump forming at 748 cm⁻¹ increases with increasing concentration of Li[TFSI] salt (larger extent of Li-TFSI interaction with increasing concentration). Deconvolution of changes to the —CF₃ vibrations at various concentrations of added lithium salt are shown in FIG. 3 which highlights the ratio of free versus coordinated TFSI anions. The interaction of lithium cations and TFSI anions is also demonstrated by NMR. Upon addition of Li[TFSI] salt, the carbon and fluorine peaks, that resonate from —CF₃ of the anion, shift to higher field (lower ppm), indicative of less chemical shielding exerted by the oxygen atoms toward the neighboring carbon atoms. This is also due to strong interactions between the lithium cation and oxygen atoms (sharing electrons with Li⁺) of the TFSI anion.

Mixtures of oligoethers (with the chemical formula of CH₃O(CH₂CH₂O)ₙCH₃ (n=4 or 5, e.g., tri-, or tetra-glymes) with lithium salts have been reported to coordinate (or solvate) lithium cations to a greater extent than TFSI anions, thereby forming a complex of lithium-glyme ions. Such solvation would disrupt the aforementioned interaction between lithium cation and TFSI anion, and result in faster lithium cation mobility.

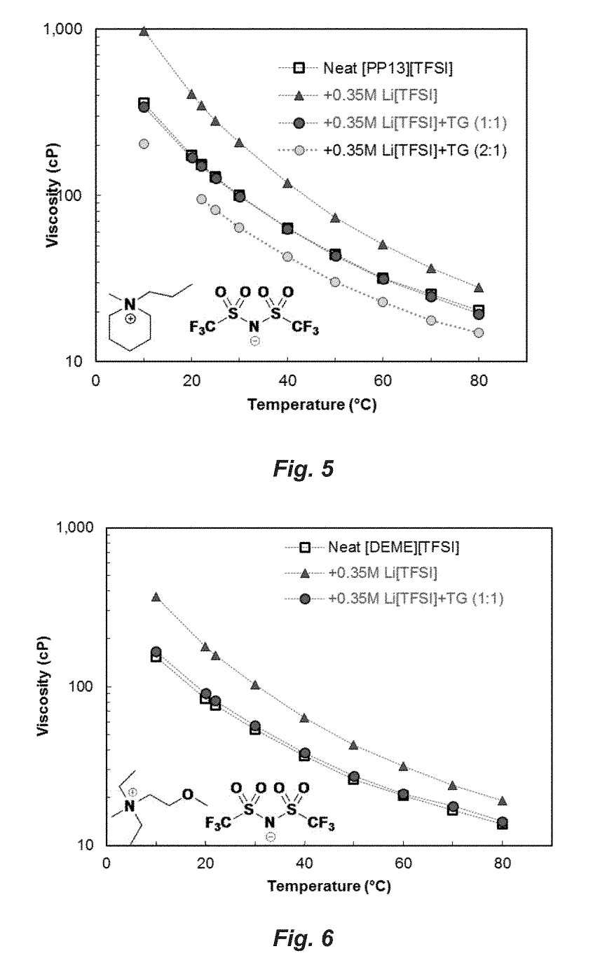

Another problem occurs when Li[TFSI] is added to an ionic liquid as shown in FIGS. 5 and 6. The addition of Li[TFSI] to the IL increases the viscosity in two ionic liquids we tested, [PP13][TFSI] and [DEME][TFSI], which have high electrochemical stability and relatively low viscosity. Fortunately, adding tetraglyme decreases the viscosity of the composition owing to the lower viscosity of tetraglyme. Surprisingly, addition of 1 mole of tetraglyme per mole of Li[TFSI] brings the viscosity back to the original viscosity value at all the tested temperatures. Addition of glyme in greater proportions further lowers viscosity, but this introduces uncomplexed glyme which is volatile in the composition (see discussion of results below).

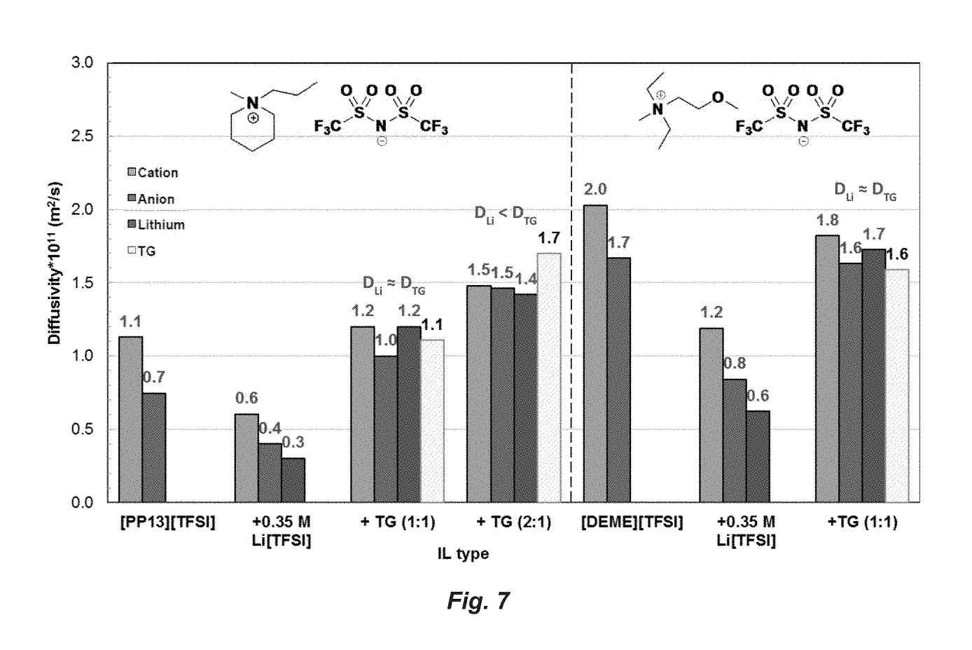

One way of testing whether tetraglyme is fully solvating the lithium cation or not is to examine the relative diffusivity of lithium cation and tetraglyme. If one expects full solvation (one lithium cation solvated by one tetraglyme molecule), the two species would behave as one complex cation, resulting in equal diffusivity. The diffusivities, as measured by PFG-SE NMR, are shown in FIG. 7. The diffusivity of lithium cation is less than either the cation or the anion when there is no tetraglyme. However, when 1 mole of tetraglyme is added per mole of lithium cation (or per mole Li[TFSI]), the diffusivities of the cation, the anion, the lithium cation and the tetraglyme are all virtually the same. When there is excess tetraglyme (greater than 1:1 ratio as in the example for [PP13][TFSI]), free tetraglyme molecules that are not solvating lithium cation causes the diffusivity of tetraglyme to increase (D_{Li}<D_{TG}). These trends are similar for both ionic liquids of [PP13][TFSI] and [DEME][TFSI].

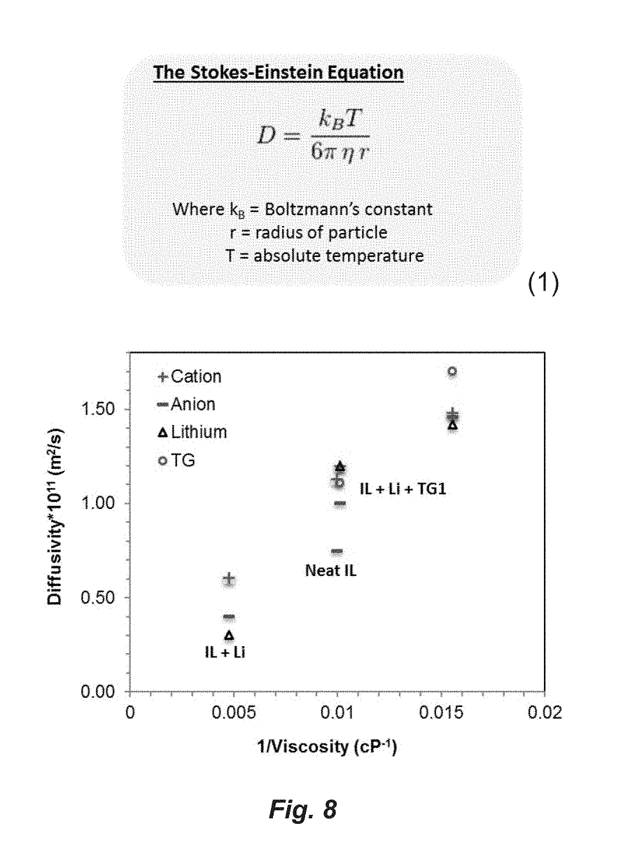

FIG. 8 compares the diffusivity, as calculated from the Stokes-Einstein relation (Eq. 1), of each individual species in the IL-salt or IL-salt-TG mixtures at the given viscosities. From the graph, it is clear that diffusivities of cation (+) and anion (−) are faster than that of Li⁺ (Δ) when there is no TG added. When TG (◯) is added in 1:1 ratio, the diffusivity of Li⁺ is equivalent to that of TG, and both are comparable to the diffusivity of IL, confirming increased mobility of Li⁺ (plus TG complex). Addition of excess TG generates free TG molecules, resulting in faster mobility of TG than any other species in the mixture.

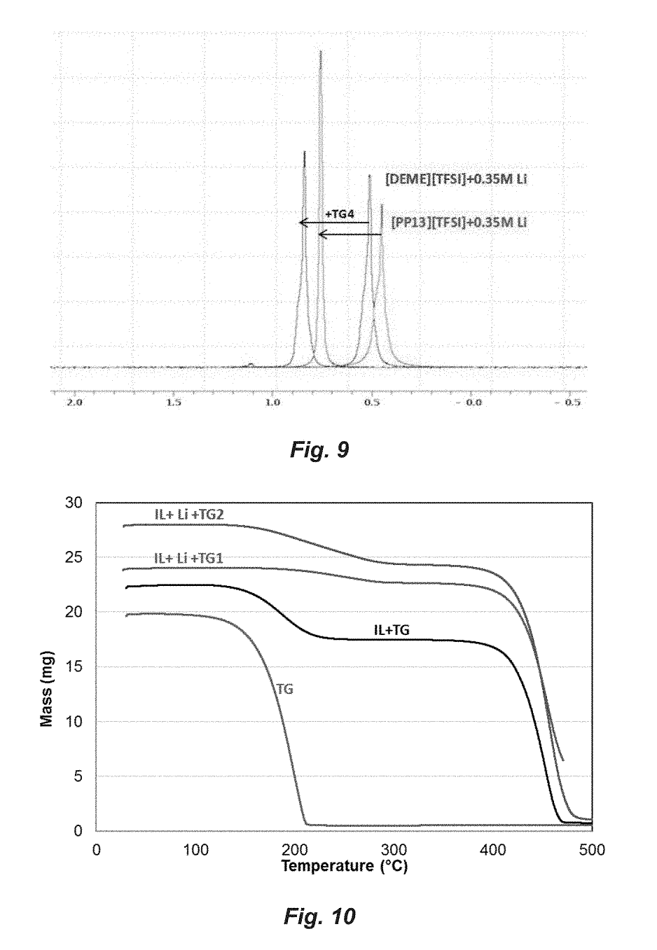

The effect of tetraglyme's association with metal ions can be observed in chemical shifts in the ⁷Li NMR spectrum (FIG. 9). Addition of TG decreases the chemical shift of the ⁷Li signal to lower field due to deshielding effects of stronger Li-TG interactions compared to Li-Anion interactions.

The vapor pressure of tetraglyme becomes negligible at lower temperatures (about less than 200° C.) when it solvates a metal cation because its molecular characteristics change. Without solvation, tetraglyme is more volatile than an ionic liquid or a lithium salt. Thus, tetraglyme would evaporate at lower temperatures faster during Thermo Gravimetric Analysis (TGA), which is an experiment that measures changes in mass due to evaporation as temperature is gradually raised.

When the stoichiometric affords full solvation between a lithium cation and tetraglyme, the tetraglyme becomes a part of the complex cation, and is less prone to evaporation compared to free tetraglyme. The mass change of the complex during a TGA experiment at higher temperatures may result from decomplexation, thereby releasing the volatile form of tetraglyme.

The results of a TGA experiments is shown in FIG. 10 for mixtures comprising of [PP13][TFSI], Li[TFSI], and tetraglyme. The data confirms that the tetraglyme is much less volatile when it is solvating the lithium cation. When only tetraglyme is present, it evaporates in the range between 150° C. and 200° C. In a mixture of just IL and tetraglyme, tetraglyme evaporates at a similar temperature range. However, when there is a 1:1 ratio of lithium to tetraglyme, there is very little mass loss until over 400° C. This is because the lithium and the tetraglyme form an essentially nonvolatile complex. When extra tetraglyme is present (the 1:2 ratio), the ‘free’ tetraglyme evaporates at lower temperatures (around 175° C.). This means that the glyme additive, if it is not present in excess, would not be volatile and would not pose the same flammability problems experienced with normal organic solvents.

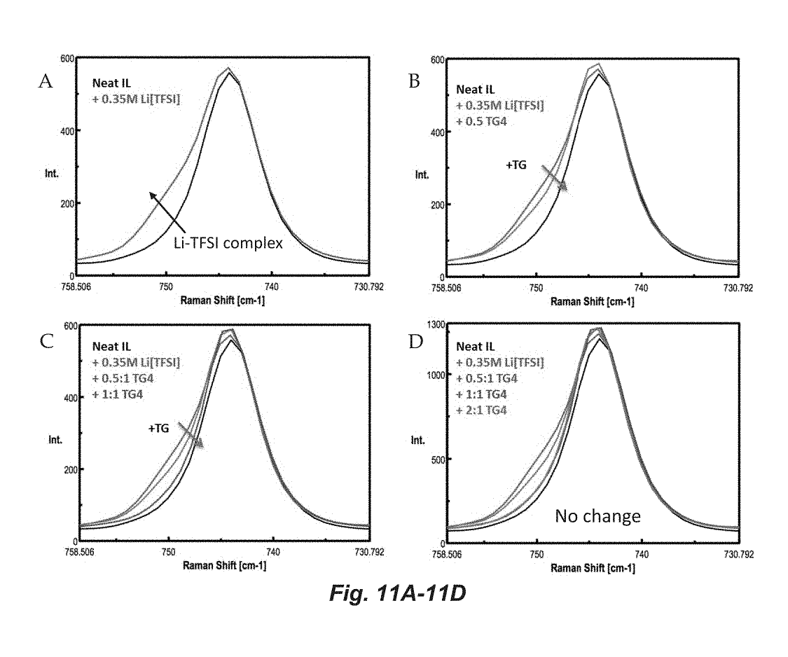

Examination of the Raman spectrum of ionic liquid compositions comprising lithium salt and varying amounts of tetraglyme shows the effect of the organic solvate on the Raman −CF₃ shift (FIG. 11). Without tetraglyme, we observe the small bump at 728 cm⁻¹ due to the formed lithium-TFSI complex. Addition of a small amount of tetraglyme (0.5 mol TG per mole Li) starts to reduce the hump since only about half of the lithium cations are coordinated with tetraglyme. Addition of 1:1 ratio of TG to Li causes the hump to disappear, confirming the presence of free TFSI anions (Li-TFSI complex broken up by preferred formation of Li-TG complex). Further addition of excess tetraglyme does not affect the spectrum (all TFSI anions are freed with just 1:1 ratio of TG to Li).

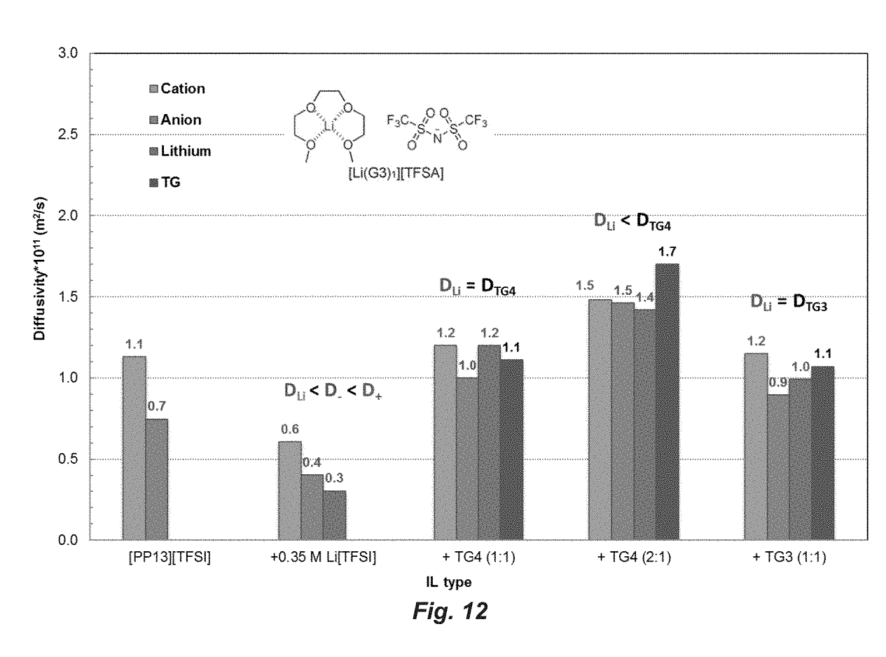

Triglyme (G3) is also capable of solvating lithium cations. We observed that addition of G3 to a IL-lithium salt mixture can enhance the lithium cation mobility by complete solvation (FIG. 12). Similar trends in diffusivity are observed with triglyme as were observed with tetraglyme, described above. Diffusivity of all ions decrease when 0.35M Li[TFSI] is added to [PP13][TFSI]. When triglyme is added to this mixture in a 1:1 ratio with lithium cation the diffusivity of all ions is on par with the diffusivity of triglyme, as seen similarly with tetraglyme.

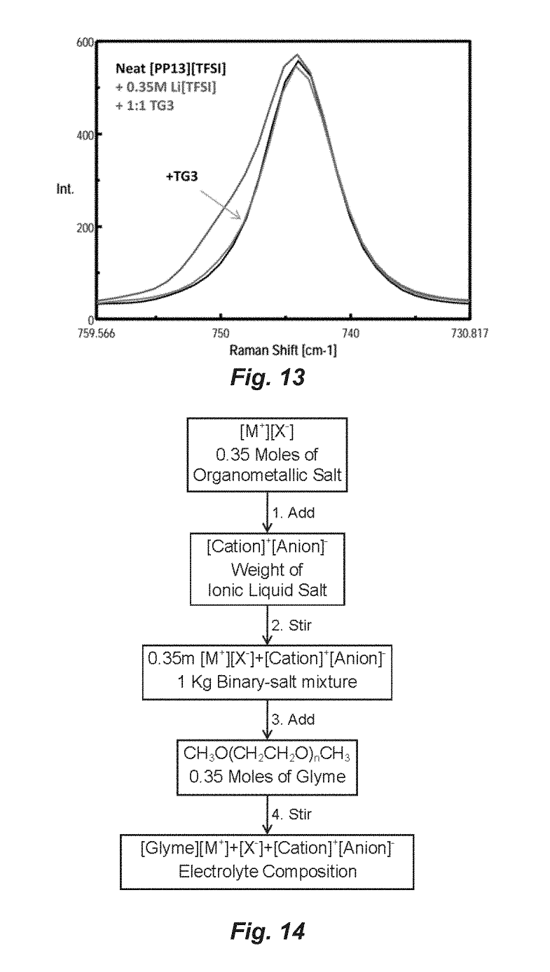

Raman spectra evidence of triglyme's ability to solvate lithium cation is shown in FIG. 13. As observed with tetraglyme, we see the hump on the —CF₃ peak due to the lithium cation and TFSI complex diminish to the Raman signal of free TFSI upon addition of G3 in a 1:1 ratio with Li[TFSI].

Thus, tri- or tetraglyme is capable of solvating lithium ion when added in equimolar ratio (1 mol of glyme per mol of lithium salt), resulting in a ‘solvate IL’ (that is, without an organic ionic liquid being used as the main electrolyte). To perturb the lithium-anion coordination in a binary IL-lithium salt mixture, just enough tetraglyme was added to the binary IL-lithium salt mixture (1 mole tetraglyme per mol lithium salt) to solvate the lithium cation and to increase the lithium cation diffusivity. For example, we prepared a mixture of diethylmethyl(2-methoxyethyl)ammonium bis(trifluoromethylsulfonyl)imide ([DEME][TFSI]) containing 0.35M lithium bis(trifluoromethanesulfonyl)imide (Li[TFSI]), then added tetraglyme, (in 1:1 molar ratio with the lithium salt) for diffusivity measurements, which produced surprising results in our experiments. The overall composition had less glyme than the corresponding solvate IL, yet the viscosity of the binary salt composition was less and the diffusivity of ions in the composition increased relative to the mixture without tetraglyme.

A general method of preparing ionic liquid compositions with improved mobility or transport of lithium cations by glyme complexation is shown in the flow diagram, FIG. 14. For example, 0.35 moles of Li[TFSI] (represented by [M⁺][X⁻]) is added in step 1 to an ionic liquid of a calculated weight to produce 1 Kg of the mixture, wherein [Cation]⁺[Anion]⁻ are two organic ionic moieties forming the salt. After stirring in step 2, a homogeneous binary salt mixture containing 0.35 m Li[TFSI] is prepared. To this mixture, 0.35 moles of a desired glyme is added in step 3. Finally, the electrolyte composition is ready after stirring in step 4.

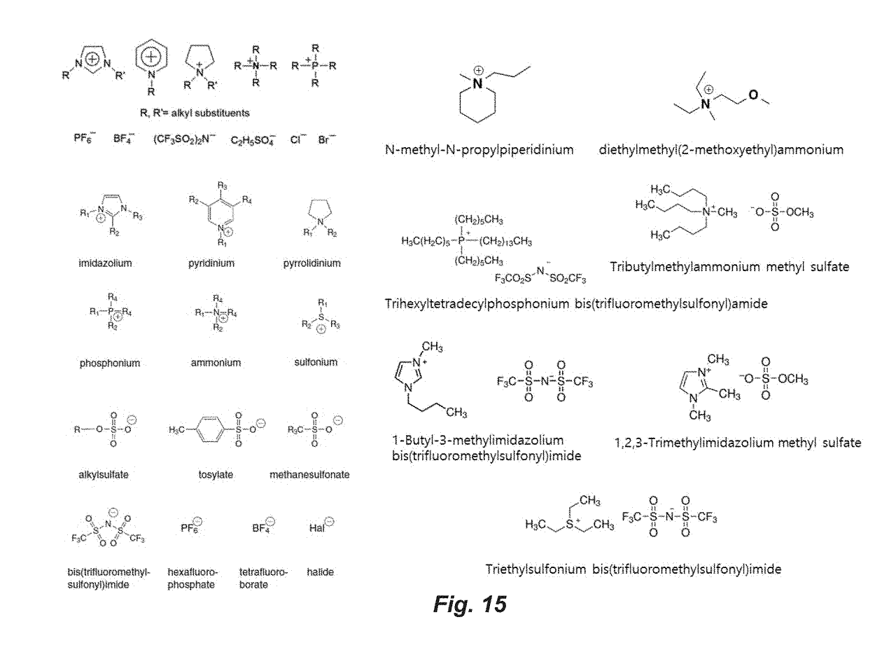

FIG. 15 shows examples of some cations and anions that can form ionic liquids, and shown are other examples of specific organic ionic salts. Some representative organic cations include, but are not limited to imidazolium, pyridinium, piperidinium, ammonium, phosphonium, and sulfonium. The choice of the anion is more critical. Donor properties of anions that are less-basic are less likely to interact strongly with the lithium cation, and therefore preferred. If the anion is too basic, addition of glyme may be less effective in breaking the metal-anion interaction that is necessary to solvate the metal cation. Therefore, examples of anions that would work well with glymes include, but are not limited to, TFSI and ClO₄⁺.

Use of glymes to solvate metal cations other than lithium cation is possible. For example, cations of sodium or potassium (which are larger in size than Li⁺) could be solvated by longer oligoethers, such as CH₃O(CH₂CH₂O)ₙCH₃ when n=5 for Na⁺ or n=6 for K⁺. Crown ethers, sized with the appropriate number of oxygens would also solvate metal ions that correspond in size.

In addition to safety, another advantage of the present disclosure over solvate ionic liquids is our compositions are “tunable”. In other words, our IL+Li salt+glyme system makes it possible to tune physical properties, such as viscosity, diffusivity, conductivity, electrochemical window, etc., by varying the components making up the composition of the electrolyte. For instance, in the spectrum of diffusivity of lithium ion, using the diffusivity of the published G4-Li[TFSI] solvate ionic liquid as a point of reference (which has the highest diffusivity (1.31×10⁷ cm²/s) among all solvate ILs), the [PP13][TFSI]+Li salt+glyme system can be tuned to a diffusivity at the lower end of the spectrum. On the opposite end of the diffusivity spectrum, the diffusivity of [DEME][TFSI]+Li salt+G4 can be tuned at the higher end of diffusivity. A similar comparison can be made using the viscosity of the solvate IL as a reference value (cP=81).

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is di-substituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±200/%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

An “effective amount” refers to an amount effective to bring about a recited effect, such as an amount necessary to form products in a reaction mixture. Determination of an effective amount is typically within the capacity of persons skilled in the art, especially in light of the detailed disclosure provided herein. The term “effective amount” is intended to include an amount of a compound or reagent described herein, or an amount of a combination of compounds or reagents described herein, e.g., that is effective to form products in a reaction mixture. Thus, an “effective amount” generally means an amount that provides the desired effect.

The term “substantially” as used herein, is a broad term and is used in its ordinary sense, including, without limitation, being largely but not necessarily wholly that which is specified. The term “ionic liquid” (or “molten salt”) refers to a salt in the liquid (or molten state). In some contexts, the term refers to salts whose melting point is below 100° C., is near or below room temperature, or is near or below ambient temperature. A salt is a molecule having a cation and an anion forming an ionic bond, which is usually stronger than the Van der Waals forces between the molecules of ordinary liquids. Examples include compounds based on the 1-ethyl-3-methylimidazolium (EMIM) cation.

While ordinary liquids such as water are predominantly made of electrically neutral molecules, ionic liquids are largely made of ions. These substances are variously called liquid electrolytes, ionic melts, ionic fluids, fused salts, liquid salts, or ionic glasses.

Ionic liquids are described as having many potential applications at near room temperature and low temperatures. They can be used in catalysis, gas handling, pharmaceuticals, cellulose processing, nuclear fuel reprocessing, solar thermal energy, waste recycling, carbon, capture, and electric batteries. However, ionic liquids are often moderate to poor conductors of electricity, non-ionizing, highly viscous, and frequently exhibit low vapor pressure.

Room temperature ionic liquids consist of bulky and asymmetric organic cations such as, but not limited to, 1-alkyl-3-methylimidazolium, 1-alkylpyridinium, N-methyl-N-alkylpyrrolidinium and ammonium ions, and also phosphonium cations. A wide range of anions are employed, ranging from, but not limited to, simple halides, which generally suffer high melting points, to inorganic anions such as tetrafluoroborate and hexafluorophosphate, and to large organic anions like bistriflimide (synonymously referred to as, bis(trifluromethylsulfonyl)imide, or TFSI), triflate or tosylate. There are also many potential uses of ionic liquids with simple non-halogenated organic anions such as formate, alkylsulfate, alkylphosphate or glycolate.

An electric battery is a device consisting of one or more electrochemical cells with external connections provided to power electrical devices such as flashlights, smartphones, and electric cars. The term “battery” is a common term to describe an electrochemical storage system. A “cell” is a basic electrochemical unit that contains the basic components, such as electrodes, separator, and electrolyte. A “battery” or “battery pack” is a collection of cells or cell assemblies which are ready for use, as it contains an appropriate housing, electrical interconnections, and possibly electronics to control and protect the cells from failure. In this regard, the simplest “battery” is a single cell with perhaps a small electronic circuit for protection.

A lithium-ion battery or Li-ion battery is a type of rechargeable battery in which lithium ions move from the negative electrode to the positive electrode during discharge and back when charging. Li-ion batteries use an intercalated lithium compound as one electrode material, compared to the metallic lithium used in a non-rechargeable lithium battery. The electrolyte, which allows for ionic movement, and the two electrodes are the constituent components of a lithium-ion battery cell.

The term “organic solvate”, in this disclosure, refers to an organic oligomer that is a liquid at room temperature or near room temperature. The organic molecule can comprise an alkyl chain of hydrocarbon atoms having moieties of heteroatoms, such as oxygen or nitrogen, spaced in-between one or more of the hydrocarbon atoms, for example, an oligoether such as a glyme. The organic solvate can also be cyclic, like a heterocycle such as a crown ether which can be of various ring sizes. In this disclosure, the organic solvate coordinatively binds to, complexes, or chelates cations, such as metal ions, for example, but not limited to, lithium cations. The complex which is formed by the organic solvate and the metal ion can be represented as, for example, a [metal ion][glyme] complex.

The term “binary-salt”, in this disclosure, refers to the combination or mixture of two or more salts. For example, an ionic liquid (IL), consisting of the salt formed from an organic cation ([organic]⁺) and an organic anion ([organic]⁻), in a mixture with an organometallic salt, the organometallic salt consisting of a metal cation ([M+]) and an organic anion ([organic]⁺).

### Embodiments of the Invention

In a first embodiment, an ionic composition comprises an organic salt having ionic liquid properties below 100° C., and an organometallic salt, wherein a binary-salt mixture of the organic salt and the organometallic salt has ionic conductivity; and

an organic solvate (S) having properties to a) chelate a metal cation (M), b) increase the diffusivity of ions in the binary-salt mixture, and c) lower the viscosity of the binary-salt mixture,

wherein the organic solvate binds to the metal cations of the organometallic salt by coordination bonds to weaken the electrostatic interaction of the metal cations with the anions of the mixture, thereby solvating the metal cations from the anions and increasing the ionic conductivity of the binary-salt mixture;

wherein the stoichiometric ratio of the organic solvate (S) and the metal cation (M) in the ionic composition ranges from about 10(S):90(M) to about 70(S):30(M), the vapor pressure of the ionic composition is negligible, and the ionic composition has lower viscosity than a corresponding binary-salt mixture of the organic salt and the organometallic salt that lacks the organic solvate.

In some embodiments, the binary-salt mixture or the ionic composition has ionic conductivity at 30° C. in the range of about 0.1 mS/cm to about 15 mS/cm, about 0.5 mS/cm to about 10 mS/cm, about 0.1 mS/cm to about 5 mS/cm, or about 1 mS/cm to about 5 mS/cm. In other embodiments, the viscosity of the ionic composition ranges from about 10 cP to about 1000 cP, about 10 cP to about 500 cP, about 10 cP to about 250 cP, about 20 cP to about 150 cP. In yet other embodiments, a negligible vapor pressure of the ionic composition is about 10⁻¹⁰ Pa, or 10⁻¹⁰ Pa within 3 orders of magnitude, within 2 orders of magnitude, or within 1 order of magnitude.

In various embodiments, the anion of the organic salt, the organometallic salt, or a combination thereof is bis(trifluoromethylsulfonyl)imide ([TFSI]), bis(pentafluoroethylsulfonyl)imide ([BETI]), tetrafluoroborate, hexafluorophosphate, or perchlorate.

In other embodiments, the organic solvate comprises ethylene glycol moieties. Embodiments also include the metal cation of the organometallic salt which can be a cation of lithium, sodium, magnesium, potassium, or calcium.

In other embodiments, the organic cation of bis(trifluoromethylsulfonyl)imide ([TFSI]), bis(pentafluoroethylsulfonyl)imide ([BETI]), tetrafluoroborate, hexafluorophosphate, or perchlorate is N,N-diethyl-N-methyl(2-methoxyethyl)ammonium ([DEME]), N-methyl-N-propylpiperidinium ([PP13]), 1-n-butyl-3-methylimidazolium ([C₄mim]), triethylsulfonium, trihexyltetradecylphosphonium, or a combination thereof.

In additional embodiments, the concentration of the organometallic salt ranges from about 0.1 molal to about 2 molal, about 0.1 molal to about 1 molal, or about 0.1 molal to about 0.5 molal, in a binary-salt mixture of the organometallic salt and the organic salt. In other embodiments, the organic solvate is diglyme, triglyme, tetraglyme, dimethoxyethane, or diethoxyethane. In various embodiments, the stoichiometric ratio of the organic solvate (S) and the metal cation (M) in the ionic composition is about 50(S):50(M), or is about 2(S):1(M).

In additional embodiments, the organic solvate is tetraglyme, and the organometallic salt is lithium bis(trifluoromethylsulfonyl)imide (Li[TFSI]). In further embodiments, the composition comprises an organic salt of [DEME][TFSI], an organic salt of [PP13][TFSI], or a combination thereof.

In yet other various embodiments, the composition comprises a mixture of [DEME][TFSI] containing about 0.3 molal Li[TFSI] to about 0.4 molal Li[TFSI], a mixture of [DEME][TFSI] containing about 0.35 molal Li[TFSI], a mixture of [PP13][TFSI] containing about 0.3 molal Li[TFSI] to about 0.4 molal Li[TFSI], or a mixture of [PP13][TFSI] containing about 0.35 molal Li[TFSI].

In additional embodiments, the self-diffusion coefficient of the lithium cation at least doubles, or at least triples relative to a corresponding composition that lacks the organic solvate. The self-diffusion coefficient of the lithium cation can increase by about 25%, about 50%, about 100%, about 150%, about 200%, about 300%, or about 500%. The self-diffusion coefficient of the lithium cation can also increase by a multiplication factor of about 2 to about 1000, 2 to about 500, 2 to about 100, or 2 to about 10.

In other embodiments, the self-diffusion coefficient of each ion in the composition is about the same as the self-diffusion coefficient of the organic solvate. In yet other embodiments, the diffusivity of each ion individually ranges from about 0.1×10¹¹ m²/s to about 5×10¹¹ m²/s, about 0.1×10¹¹ m²/s to about 3×10¹¹ m²/s, about 0.5×10¹¹ m²/s to about 2.5×10¹¹ m²/s, or about 1×10¹¹ m²/s to about 2.5×10¹¹ m²/s.

Other embodiments include a battery, or an electrochemical cell containing an electrolyte comprising the composition or the properties of all the various embodiments of this disclosure.

In a second embodiment, an ionic composition comprises a) an organic salt comprising N,N-diethyl-N-methyl-N-(2-methoxyethyl)ammonium bis(trifluoromethylsulfonyl)imide ([DEME][TFSI]), N-methyl-N-propylpiperidinyl bis(trifluoromethylsulfonyl)imide ([PP13][TFSI]), or a combination thereof,

b) an organometallic salt comprising lithium bis(trifluoromethylsulfonyl)imide (Li[TFSI]); and

c) a glyme (G) selected from diglyme, triglyme, tetraglyme, or a combination thereof, wherein the stoichiometric ratio of the glyme (G) and the lithium cation (M) of the organometallic salt is about 50(G):50(M), and concentration of Li[TFSI] is in the range of about 0.3 molal to about 0.4 molal in a mixture of Li[TFSI] and [DEME][TFSI], in a mixture of Li[TFSI] and [PP13][TFSI], or in a mixture of Li[TFSI], [DEME][TFSI], and [PP13][TFSI]. One of the embodiments includes a battery, or an electrochemical cell containing an electrolyte comprising this composition, or the composition of other embodiments.

A third embodiment includes a method to increase the self-diffusion coefficient of ions in a composition. The method comprises adding an organic solvate to a binary-salt mixture of an organic salt having ionic liquid properties below 100° C., and an organometallic salt to form an ion conducting composition, wherein the stoichiometric ratio of the organic solvate (S) and the metal cation (M) of the organometallic salt ranges from about 60(S):40(M) to about 40(S):60(M), and the concentration of the organometallic salt ranges from about 0.1 molal to about 1 molal in said mixture;

wherein, relative to the binary-salt mixture of the organic salt and the organometallic salt, the ion conducting composition has a) an increased self-diffusion coefficient, b) a higher conductivity, and c) a lower viscosity, and the vapor pressure of the ion conducting composition is negligible.

In various embodiments, the organic solvate is tetraglyme, the organic salt is N,N-diethyl-N-methyl-N-(2-methoxyethyl)ammonium bis(trifluoromethylsulfonyl)imide ([DEME][TFSI]), or the organic salt is N-methyl-N-propylpiperidine ([PP13][TFSI]), and the organometallic salt is lithium bis(trifluoromethylsulfonyl)imide (Li[TFSI]).

In additional embodiments, the stoichiometric ratio of tetraglyme (S) and the lithium cation (M) in the composition is about 50(S):50(M), and the concentration of Li[TFSI] is in the range of about 0.3 molal to about 0.4 molal in the mixture of Li[TFSI] and [DEME][TFSI], or the concentration of Li[TFSI] is in the range of about 0.3 molal to about 0.4 molal in the mixture of Li[TFSI] and [PP13][TFSI].

In other embodiments, relative to the mixture of Li[TFSI] and [DEME][TFSI], or relative to the mixture of Li[TFSI] and [PP13][TFSI], or relative to other organic ionic liquids, the self-diffusion coefficient of lithium increases in the composition.

This disclosure describes lithium salts in an organic ionic liquid which have increased mobility when the lithium salt is combined with an organic solvate such as a glyme, wherein only a fraction of the amount of glyme in the total composition is used compared to a solvate ionic liquid, and that fraction being non-volatile because it is complexed with a metal ion.

The advantages of using and ionic liquid with above said improvements when compared to molecular solvents are several-fold: 1) little to no vapor pressure below 100° C., 2) can be formulated with many possible combinations of ionic liquids, 3) non-flammable behavior, 4) improved conductivity, and 5) high solubility of metal salts. In particular, the non-flammability, high conductivity, and dissolution of metal salts make these liquids an intriguing option for electrolytes in lithium batteries, which would enable lithium batteries of the future to be more safe than they are today.

These advantages have led to acknowledgement of the potential for ionic liquids to provide a valuable alternative solvent option. Many molecular solvents have high vapor pressures, leading to release of volatile organic compounds (VOCs) which are harmful to the environment. VOC emissions currently hinder large scale syntheses in industry, so ionic liquids are ‘greener’ solvents due to their low vapor pressures. Ionic liquids are highly tunable; both changing the ratio of cation to anion and using a different cation or anion can drastically change its properties. Therefore, the properties of potentially any ionic liquid can benefit from a composition which includes the [metal ion][glyme] complex described in this disclosure.

Preferably, the ionic liquid has a melting point of no more than about 100 degrees Celsius, a decomposition temperature of at least about 200 degrees Celsius, a viscosity of less than about 1000 centipoise (cP), an ionic conductivity of at least about 0.01 mS/cm, and an electrochemical window of at least about 4 Volts. The vapor pressure of an ionic liquid is preferably about of the order of 10⁻¹⁰ Pa at 25° C. A negligible vapor pressure would be about 10⁻¹⁰ Pa at 25° C. within 3 orders of magnitude, 2 orders or magnitude, or 1 order of magnitude.

The ionic liquid can be any suitable electrochemically and thermally stable ionic liquid having a relatively low melting point, preferably less than about 100° C. and more preferably from about −5 to about −125° C. Preferably, the ionic liquid has a relatively high thermo-decomposition temperature (e.g., remain substantially thermally stable at temperatures of about 400° C. or less), a suitable hydrophobic to hydrophilic ratio such that it has the ability to substantially dissolve one or more lithium-ion containing salts, a low viscosity of preferably less than about 200 cP and even more preferably ranging from about 10 to about 150 cP, a relatively high ionic conductivity at about 25° C. of at least about 0.01 mS/cm, or from about 0.05 mS/cm to about 20 mS/cm, and wide electrochemical window of preferably at least about 2 volts, more preferably at least about 4 volts, and even more preferably at least about 5 to about 20 volts.

The ionic liquid is a composition having at least one cation selected from the group consisting essentially of ammonium, imidazolium, pyrrolidinium, pyridinium, phosphonium, and sulfonium, and at least one anion selected from the group consisting essentially of alkylsulfate, tosylate, methanesulfonate, bis(trifluoromethylsulfonyl)imide ([TFSI]), bis(pentafluoroethylsulfonyl)imide ([BETI]), hexafluorophosphate, tetrafluoroborate, perchlorate, and halide. Preferred cations are N-methyl-N-propylpiperidinium, N,N-dimethyl-N-ethyl(2-methoxyethyl)ammonium, and N,N-diethyl-N-methyl(2-methoxyethyl)ammonium. Preferred anions are bis(trifluoromethylsulfonyl)imide, bis(pentafluoroethylsulfonyl)imide, and perchlorate.

Ionic liquids include ethyldimethylpropylammonium bis(trifluoromethylsulfonyl)imide, N,N-diethyl-N-methyl(2-methoxyethylammonium bis(trifluormethylsulfonyl)imide, N,N-dimethyl-N-ethyl(2-methoxyethylammonium bis(trifluormethylsulfonyl)imide, 1-butyl-1-methylpyrrolidinium bis(trifluoromethylsulfonyl)imide, tributylmethylammonium methyl sulfate, trihexyltetradecylphosphonium bis(trifluoromethylsulfonyl)amide, 1-n-butyl-3-methylimidazolium bis(trifluoromethylsulfonyl)imide, 1,2,3-trimethylimidazolium methyl sulfate, triethylsulfonium bis(trifluoromethylsulfonyl)imide, and 1-butyl-1-methylpyrrolidinium dicyanamide.

The lithium salt can be any lithium salt that can be solvated by glyme. Lithium salts having substantial thermal stability and solubility in the ionic liquid are preferred. Non-limiting examples of preferred lithium salts comprise; lithium hexafluorophosphate, lithium chloride, lithium bromide, lithium hexafluoroarsenate, lithium perchlorate, lithium tetrafluoroborate, lithium bis(trifluoromethylsulfonyl)imide, lithium tris(trifluoromethylsulfonyl)methide, and lithium bis(oxalato) borate. The lithium salt concentration ranges from about 0.05M to about 5 M (based on the molar concentration of the lithium salt), or lithium salt concentrations ranges from about 0.1 M to about 2.5 M.

Mixing Glymes with Ionic Liquids Changes Transport Properties

Ionic liquids (ILs) have properties that make them useful in devices such as batteries and solar cells, and in applications such as catalysis, chemical separations, and solvents for synthesis and electrochemistry. Ls can have a low melting point (e.g., less than 22° C. or less than 0° C.) and negligible vapor pressure. They also have excellent thermal and electrochemical stability.

However, ILs are typically more viscous than conventional solvents used in various synthetic and apparatus applications. The higher viscosity can pose problems for such methods and devices. Certain combinations of cations and anions have reduced viscosity and increased diffusivity and various “design rules” are used to discover and evaluate ILs with low viscosity. The design rules include that larger ions often lead to higher viscosity. Several exceptions to the rules are discussed by Sharma et al., Chem. Eng. Sci., 2017, 159, 43-57, at 43-44. For example, when the cation 1-n-butyl-3-methylimidazolium ([C₄mim]) is paired with the “planar” pyrrolide ([Pyl]) anion, the dynamics are significantly higher than when the [C₄mim] cation is paired with the [TFSI] anion, despite [Pyl] being “larger” than [TFSI]. This situation may be the result of differences in the liquid phase packing structure of the two different ILs. Another possibility is that dynamics increase and viscosity decreases when interactions between the cation and anion are reduced. However, a reverse trend can also be observed with 1-n-butyl-2,3-dimethylimidazolium hexafluorophosphate ([C₄mmim][PF₆]), which has a higher viscosity than 1-n-butyl-3-methylimidazolium hexafluorophosphate ([C₄mim][PF₆]). This situation may be a result of the entropy of the liquid phase. Transport properties of ILs become even more complex in chemical reactions.

The dynamics of ILs can be modulated by combining different cations and anions, or by mixing various different pairs of cations and anions. However, a more efficient method to obtain a lower viscosity can be to mix an IL with a low viscosity additive, e.g., an organic solvent. The addition of a low viscosity solvent, even in a small amount, can have a significant effect on the viscosity of the IL/solvent mixture. The viscosity decrease is, however, unpredictable. A solvent with a lower viscosity does not always decrease the viscosity more than a solvent with higher viscosity. Relevant factors affecting the resulting viscosity include the nature of both the solvent and the ions of the IL.

When combining a molecular solvent with an IL, the finite vapor pressure of the diluent can compromise the extremely low volatility of the IL. In some instances, this disadvantage can be overcome by mixing an IL with a molecular solvent that has a very low volatility itself, such as a glyme. Glymes are an oligoethers class of compounds of the general formula CH₃O—(CH₂CH₂O)ₙ—CH₃ where n is 1 to about 10, typically 2-5, although larger for PEG polymers. Glymes have low volatility and are effective at dissociating salts because of the electron donating nature of their ether oxygen groups. Glymes typically have high thermal and electrochemical stability. Several groups have investigated mixing glymes with alkali metal salts for use as electrolytes in batteries. The alkali metal cation can coordinate with the oxygen atoms of the glyme, thereby lowering the melting point of the salt. These systems have improved transport properties but retain the useful properties of pure ILs. These systems are referred to a new class of ILs termed “solvate ILs”. Tetraethylene glycol dimethyl ether (tetraglyme, TG4, or G4) is a useful example of one glyme that readily dissolves many salts and has a vapor pressure of only 0.132 kPa at 100° C.

We are unaware of any studies that have investigated the properties of conventional imidazolium-based ILs mixed with glymes. In one study of a model system with our collaborators (Sharma et al., Chem. Eng. Sci., 2017, 159, 43-57), the density, viscosity and conductivity of [C₆mim][TFSI] and its mixtures with tetraglyme were measured at different temperatures and concentrations. Certain points that are raised in the Sharma et al. reference are noteworthy in light of this disclosure. First, a decreases in the viscosity of [C₆mim][TFSI] upon addition of tetraglyme does not follow an ideal mixing model. Without experimentation, it is not possible to predict the extent of changes in viscosity when an ionic liquid is mixed with a glyme. Furthermore, the solvation chemistry between a metal salt, an ionic liquid and a glyme in our composition adds to the complexity of the dynamics of mixing. As we observed, the viscosity of our binary-salt ionic liquid compositions either increased or decreased depending on the ratios of each component in the composition.

The diffusivity of the ions in the composition are dependent on the viscosity of the composition (FIG. 18). Our experiments showed that it is possible to formulate (FIG. 14) a binary-salt ionic liquid composition within a certain range of concentrations of the [lithium-salt][glyme] complex in an ionic liquid that has better diffusivity of ions (FIGS. 7 and 12) than the ionic liquid alone, while maintaining low volatility (FIG. 10) even at temperatures exceeding that which are considered normal operating temperatures for many electrochemical devices.

Ionic liquids have drawn the attention of researchers due to their promising potential in various application areas, including electrolytes for energy storage. Unfortunately, their relatively high viscosity compared to many molecular solvents has been a draw back. Mixing ILs with low viscosity molecular solvents is a potential solution to this problem and has been the focus of many studies in recent years. Understanding how molecular solvents lower mixture viscosity and by how much is therefore an important issue.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### Examples

### Preparation of 0.35 Molal Solution of Lithium Salt in an Ionic Liquid of [TFSI] Containing 1 Mole Equivalent of Glyme

A. The weight of an organometallic salt corresponding 0.35 moles was added to a sufficient weight of an ionic liquid to make a binary-salt mixture with a total weight of 1 kilogram. The mixture was stirred to make a uniform mixture, then 1 mole equivalent of an organic solvate (based on the moles of organometallic salt) was added to the mixture with additional stirring, such that the ratio of the organometallic salt and the organic solvate is 1:1, to form the electrolyte composition (FIG. 14).

B. The weight of Li[TFSI] corresponding 0.35 moles was added to a sufficient weight of [PP13][TFSI] to make a binary-salt mixture with a total weight of 1 kilogram. The mixture was stirred to make a uniform mixture then, 0.35 mole of tetraglyme was added to the mixture with additional stirring to form the binary-salt ionic liquid composition.

C. A mixture of 1 gram of 0.35 molal Li[TFSI] (mw=287.08) in [PP13][TFSI](mw=422.40) was prepared by adding 100.5 milligrams of Li[TFSI] to 899.5 milligrams of [PP13][TFSI]. The mixture was stirred vigorously for about 24 hours at room temperature. Then, 77.8 milligrams of tetraglyme (0.35 millimoles, 222.3 g/mol) was added to the stirring mixture to form the binary-salt ionic liquid electrolyte composition (having about 14 mole percent of the lithium-glyme complex) of Formula I.

14 mol % [Li/G4][TFSI]+[PP13][TFSI] (I)

D. A mixture of 1 gram of 0.35 molal Li[TFSI] (mw=287.08) in [PP13][TFSI](mw=422.40) was prepared by adding 100.5 milligrams of Li[TFSI] to 899.5 milligrams of [PP13][TFSI]. The mixture was stirred vigorously for about 24 hours at room temperature. Then, 62.4 milligrams of triglyme (0.35 millimoles, mw=178.2 g/mol) was added to the stirring mixture to form the binary-salt ionic liquid electrolyte composition (having about 14 mole percent of the lithium-glyme complex) of Formula II.

14 mol % [Li/G3][TFSI]+[PP13][TFSI] (II)

E. A 0.35 molar solution of Li[TFSI] in [DEME][TFSI] was prepared by adding 0.35 moles of Li[TFSI] in a volume of [DEME][TFSI] sufficient to make 1 liter in total volume of the mixture. Subsequently, 0.35 moles of tetraglyme was added to the mixture with stirring to form a homogeneous composition, as shown in Scheme 1.

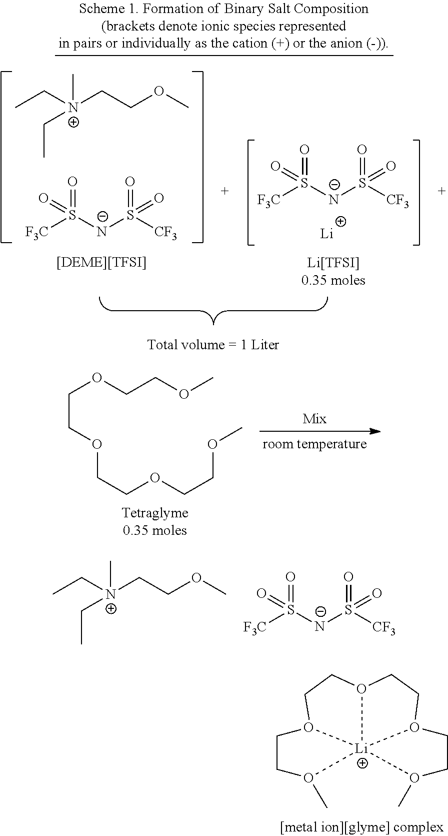

F. Any one of procedures A, or B, or C, or D, or E can be used to prepare binary-salt ionic liquid compositions that start from various concentrations of organolithium salts in an ionic liquid, wherein the concentration can range from 0.01 molar to 2.5 molar organolithium, or the concentration can range from 0.01 molal to 2.5 molal organolithium. The final composition would be prepared to include 1 mole equivalent of a glyme.

The properties of the described compositions and solvate ILs are shown in Table 1.

TABLE 1
Experimental values for Conductivity, Viscosity and Diffusivity

| | Conductivity | Viscosity | Diffusivity*10\hat{ }11 (m2/s) | | | |
|---|---|---|---|---|---|---|
| Cation | (mS/cm) | (cP) | Cation | Anion | Lithium | Glyme |
| [PP13][TFSI] | 1.93 | 100 | 1.13 | 0.74 | NA | NA |
| +0.35M Li[TFSI] | 1.11 | 209 | 0.61 | 0.4 | 0.3 | NA |
| +G4 | Not | 99 | 1.2 | 1 | 1.18 | 1.14 |
| | measured | | | | | |
| [DEME][TFSI] | 3.24 | 54 | 2.03 | 1.67 | NA | NA |
| +0.35M Li[TFSI] | 1.66 | 103 | 1.19 | 0.84 | 0.62 | NA |
| +G4 | Not | 56 | 1.82 | 1.63 | 1.71 | 1.64 |
| | measured | | | | | |
| Li[TFSI] + G4 (Solvate IL) | 1.6 | 81 | NA | 1.22 | 1.31 | 1.29 |
| Li[TFSI] + G3 (Solvate IL) | 1.1 | 169 | NA | 0.57 | 0.89 | 0.84 |

### CONCLUSION

The above teachings demonstrate that an organic ionic liquid comprising a low fraction of glyme is sufficient to reduce viscosity of the organic ionic liquid. When the ionic liquid comprises both an organometallic salt and glyme in stoichiometric equivalent amounts, improved metal ion mobility (and thereby better conductivity) results due to solvation effects. The composition has the added benefit of reducing or eliminating glyme's volatility. However, addition too much glyme can lead to unsafe high vapor pressures and may be averse to the electrolyte's conductivity.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. An ionic composition comprising:
an organic salt having ionic liquid properties below 100° C., and an organometallic salt, wherein a binary-salt mixture of the organic salt and the organometallic salt has ionic conductivity; and
an organic solvate (S) having properties to a) chelate a metal cation (M), b) increase the diffusivity of ions in the binary-salt mixture, and c) lower the viscosity of the binary-salt mixture,
wherein the organic solvate binds to the metal cations of the organometallic salt by coordination bonds to weaken the electrostatic interaction of the metal cations with the anions of the mixture, thereby solvating the metal cations from the anions and increasing the ionic conductivity of the binary-salt mixture;
wherein the stoichiometric ratio of the organic solvate (S) and the metal cation (M) in the ionic composition ranges from about 10(S):90(M) to about 70(S):30(M), the vapor pressure of the ionic composition is negligible, and the ionic composition has lower viscosity than a corresponding binary-salt mixture of the organic salt and the organometallic salt that lacks the organic solvate.

2. The composition of claim 1 wherein the anion of the organic salt, the organometallic salt, or a combination thereof is bis(trifluoromethylsulfonyl)imide ([TFSI]), bis(pentafluoroethylsulfonyl)imide ([BETI]), tetrafluoroborate, hexafluorophosphate, or perchlorate.

3. The composition of claim 2 wherein the organic solvate comprises ethylene glycol moieties.

4. The composition of claim 2 wherein the metal cation of the organometallic salt is a cation of lithium, sodium, or potassium.

5. The composition of claim 2 wherein the organic cation of bis(trifluoromethylsulfonyl)imide ([TFSI]), bis(pentafluoroethylsulfonyl)imide ([BETI]), tetrafluoroborate, hexafluorophosphate, or perchlorate is N,N-diethyl-N-methyl(2-methoxyethyl)ammonium ([DEME]), N-methyl-N-propylpiperidinium ([PP13]), 1-n-butyl-3-methylimidazolium ([C₄mim]), triethylsulfonium, trihexyltetradecylphosphonium, or a combination thereof.

6. The composition of claim 3 wherein the concentration of the organometallic salt ranges from about 0.1 molal to about 2 molal in a binary-salt mixture of the organometallic salt and the organic salt.

7. The composition of claim 3 wherein the organic solvate is diglyme, triglyme, tetraglyme, dimethoxyethane, or diethoxyethane.

8. The composition of claim 7 wherein the stoichiometric ratio of the organic solvate (S) and the metal cation (M) in the ionic composition is about 50(S):50(M), or is about 2(S):1(M).

9. The composition of claim 8 wherein the organic solvate is tetraglyme, and the organometallic salt is lithium bis(trifluoromethylsulfonyl)imide (Li[TFSI]).

10. The composition of claim 9 wherein the composition comprises an organic salt of [DEME][TFSI], an organic salt of [PP13][TFSI], or a combination thereof.

11. The composition of claim 9 wherein the composition comprises a mixture of [DEME][TFSI] containing about 0.35 molal Li[TFSI], or a mixture of [PP13][TFSI] containing about 0.35 molal Li[TFSI].

12. The composition of claim 11 wherein the self-diffusion coefficient of the lithium cation at least doubles relative to a corresponding composition that lacks the organic solvate.

13. The composition of claim 11 wherein the self-diffusion coefficient of each ion in the composition is about the same as the self-diffusion coefficient of the organic solvate.

14. A battery containing an electrolyte comprising the composition of claim 1.

15. An ionic composition comprising:
a) an organic salt comprising N,N-diethyl-N-methyl-N-(2-methoxyethyl)ammonium bis(trifluoromethylsulfonyl)imide ([DEME][TFSI]), N-methyl-N-propylpiperidinyl bis(trifluoromethylsulfonyl)imide ([PP13][TFSI]), or a combination thereof;
b) an organometallic salt comprising lithium bis(trifluoromethylsulfonyl)imide (Li[TFSI]); and
c) a glyme (G) selected from diglyme, triglyme, tetraglyme, or a combination thereof;
wherein the stoichiometric ratio of the glyme (G) and the lithium cation (M) of the organometallic salt is about 50(G):50(M), and concentration of Li[TFSI] is in the range of about 0.3 molal to about 0.4 molal in a mixture of Li[TFSI] and [DEME][TFSI], in a mixture of Li[TFSI] and [PP13][TFSI], or in a mixture of Li[TFSI], [DEME][TFSI], and [PP13][TFSI].

16. A battery containing an electrolyte comprising the composition of claim 15.

17. A method to increase the self-diffusion coefficient of ions in a composition, the method comprising:
adding an organic solvate to a binary-salt mixture of an organic salt having ionic liquid properties below 100° C., and an organometallic salt to form an ion conducting composition, wherein the stoichiometric ratio of the organic solvate (S) and the metal cation (M) of the organometallic salt ranges from about 60(S):40(M) to about 40(S):60(M), and the concentration of the organometallic salt ranges from about 0.1 molal to about 1 molal in said mixture;
wherein, relative to the binary-salt mixture of the organic salt and the organometallic salt, the ion conducting composition has a) an increased self-diffusion coefficient, b) a higher conductivity, and c) a lower viscosity, and the vapor pressure of the ion conducting composition is negligible.

18. The method of claim 17 wherein the organic solvate is tetraglyme, the organic salt is N,N-diethyl-N-methyl-N-(2-methoxyethyl)ammonium bis(trifluoromethylsulfonyl)imide ([DEME][TFSI]), or the organic salt is N-methyl-N-propylpiperidine ([PP13][TFSI]), and the organometallic salt is lithium bis(trifluoromethylsulfonyl)imide (Li[TFSI]).

19. The method of claim 18 wherein the stoichiometric ratio of tetraglyme (S) and the lithium cation (M) in the composition is about 50(S):50(M), and the concentration of Li[TFSI] is in the range of about 0.3 molal to about 0.4 molal in the mixture of Li[TFSI] and [DEME][TFSI], or the concentration of Li[TFSI] is in the range of about 0.3 molal to about 0.4 molal in the mixture of Li[TFSI] and [PP13][TFSI].

20. The method of claim 19 wherein, relative to the mixture of Li[TFSI] and [DEME][TFSI], or relative to the mixture of Li[TFSI] and [PP13][TFSI], the self-diffusion coefficient of lithium increases in the composition.
